(19) United States
(12) Patent Application Publication
(10) Pub. No.: US 2018/0054311 A1
(43) Pub. Date: Feb. 22, 2018

(54) AUTHENTICATING DEVICE FOR PERFORMING USER AUTHENTICATION BY USING PASSWORD, AND IMAGE FORMING APPARATUS

(71) Applicant: KYOCERA Document Solutions Inc., Osaka (JP)

(72) Inventor: Takeo SHIMIZU, Osaka (JP)

(73) Assignee: KYOCERA Document Solutions Inc., Osaka (JP)

(21) Appl. No.: 15/681,359

(22) Filed: Aug. 19, 2017

(30) Foreign Application Priority Data
Aug. 19, 2016 (JP) 2016-161003

(51) Int. Cl. H04L 9/32; G06F 3/0488

(52) U.S. Cl. CPC H04L 9/3226; H04L 63/083; G06F 3/0488; H04L 9/3271

(57) ABSTRACT

Provided is an authenticating device that reduces entry mistakes when entering a password due to touch mistakes in a state in which security is maintained. An image forming apparatus includes a touch panel, an authentication-processing unit, and a touch-mistake-detection unit. The touch panel displays a software keyboard on which plural input keys that indicate characters, numbers and symbols are arranged, and receives touch operations of input keys that correspond to touch positions on a display screen that displays the software keyboard. The authentication-processing unit executes user authentication by comparing an entered password that is entered by the touch panel and a set password. When the comparison result indicates there is no match, the touch-mistake-detection unit detects a touch mistake in the entered password. When a touch mistake is detected, the authentication-processing unit authenticates the entered password as the set password being entered.

### INCORPORATION BY REFERENCE

This application is based on and claims the benefit of priority from Japanese Patent Application No. 2016-161003 filed on Aug. 19, 2016, the contents of which are hereby incorporated by reference.

### BACKGROUND

The present disclosure is related to an authenticating device for performing user authentication by using a password, and an image forming apparatus.

In user authentication using a password, there are occasions when it is necessary to re-enter the password due to a mistake in entering the password or the like. Particularly, when entering a password using a software keyboard such as a touch panel and the like, often touch mistakes go unnoticed. Therefore, technology such as changing the display color of an operation button that is touch operated, enlarging the display of an operation button around the touch position, and the like has been proposed. Moreover, technology has been proposed in which on a re-entry screen for re-entering a password, characters such as asterisks “*” are displayed in the previously entered password for characters that are correctly entered so as to be unrecognizable, and characters that were mistakenly entered are displayed so as to be recognizable so that only re-entry of characters that were mistakenly entered is received.

### SUMMARY

The authenticating device according to the present disclosure includes a touch panel, an authentication-processing unit, and a touch-mistake-detection unit. The touch panel displays a software keyboard on which plural input keys that indicate characters, numbers and symbols are arranged, and receives touch operations of input keys that correspond to touch positions on a display screen that displays the software keyboard. The authentication-processing unit executes user authentication by comparing an entered password that is entered via the touch panel and a set password. When the comparison result is that there is no match, the touch-mistake-detection unit detects a touch mistake in the entered password. When a touch mistake is detected, the authentication-processing unit authenticates the entered password as the set password being entered.

### BRIEF DESCRIPTION OF THE DRAWINGS

FIG. 1 is a function block diagram illustrating an overview of the configuration of an image forming apparatus of an embodiment according to the present disclosure.

FIG. 2 illustrates an example of a password-entry screen that is displayed on the touch panel illustrated in FIG. 1.

FIG. 3 is a flowchart illustrating the flow of a password authentication process of the image forming apparatus illustrated in FIG. 1.

### DETAILED DESCRIPTION

In the following, an embodiment of the present disclosure will be explained in detail with reference to the drawings. In the embodiment described below, the same reference numbers will be used for configuration that illustrates the same function.

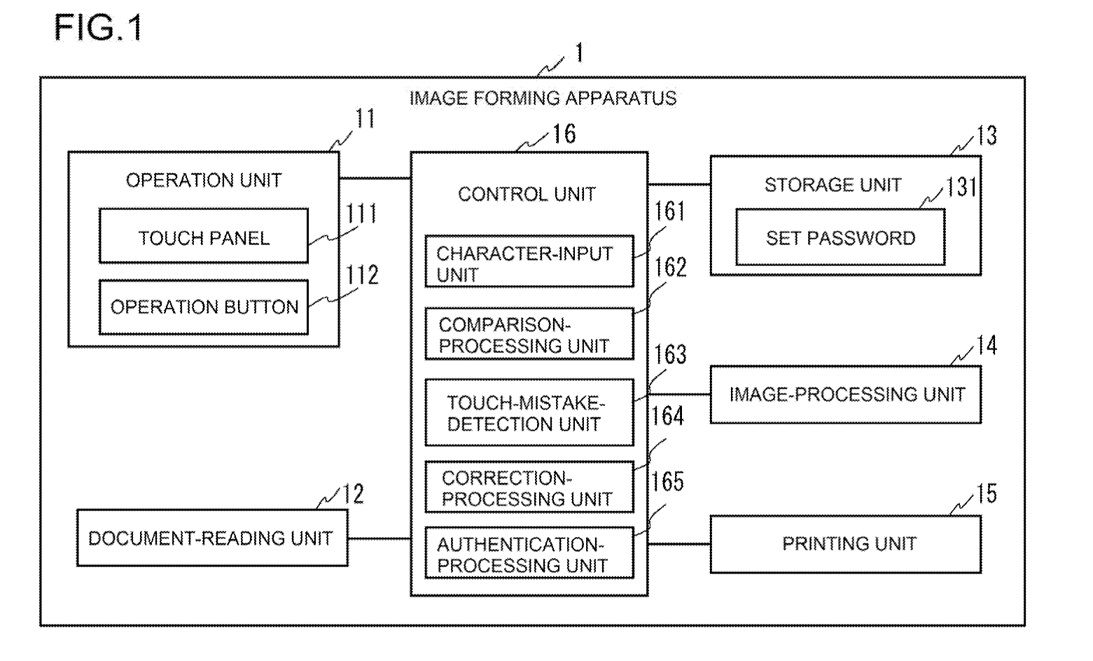

In referencing FIG. 1, the image forming apparatus 1 is a copier or MFP, and functions as an authenticating device. The image forming apparatus 1 includes an operation unit 11, a document-reading unit 12, a storage unit 13, an image-processing unit 14, a printing unit 15 and a control unit 16.

The operation unit 11 includes a touch panel 111 and operation buttons 112. The touch panel 111 is provided with transparent pressure-sensitive sensors on a display surface of a display unit that displays various operation keys and image forming status, and functions as a display unit and an input unit. The touch panel 111 detects the touch position on the display screen, and by outputting a signal that corresponds to the touch position, receives a touch operation of an operation key that is displayed on the display unit.

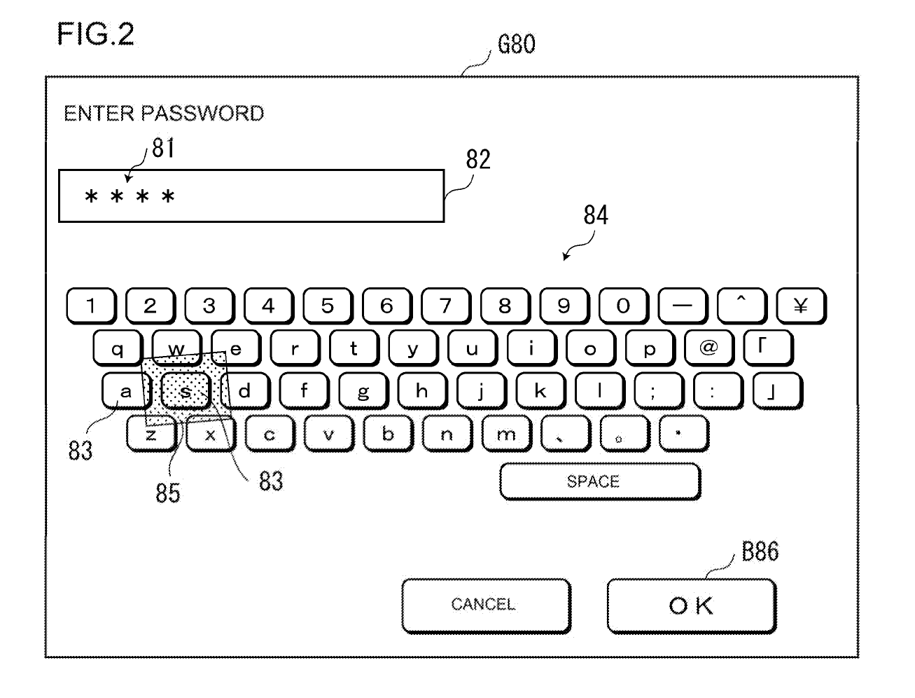

For example, as illustrated in FIG. 2, the touch panel 111 displays a software keyboard 84 on which plural input keys 83 that indicate characters, numbers or symbols are arranged, and receives touch operations of the input keys 83 that correspond to touch positions on the display screen that displays the software keyboard 84. The operation buttons 112 include various keys such as a ten-key, reset key, stop key, start key and the like. The ten-key is used for entering numerical values such as the number of pages to print and the like. The reset key is used for entering an instruction to initialize setting information. The stop key is used for stopping a copying operation. The start key is used for entering an output instruction that starts a printing operation.

The document-reading unit 12 is a scanner that irradiates light onto a document that is supplied by a document-feeding apparatus, or onto a document that is placed on a platen glass by a user, receives the reflected light or the like, and reads the document image.

The storage unit 13 is a storage unit such as a semiconductor memory, HDD or the like, and stores image data and the like that is read by the document-reading unit 12. Moreover, a preset set password 131 is stored in the storage unit 13. The set password 131 is a password for comparing in a password authentication process whether an entered password 81 that is entered by a user was entered correctly.

The image-processing unit 14 performs specific image processing on image data. In the image-processing unit 14, for example, enlargement or reduction processing, or image improvement processing such as density adjustment, tone adjustment and the like are performed.

The printing unit 15 prints image data that is stored in the storage unit 13. The printing unit 15, for example, forms a latent image on the surface of a photosensitive drum based on image data that is read from the storage unit 13, performs image formation using toner to form the latent image into a toner image, transfers the toner image from the photosensitive drum to printing paper, fixes the toner image on the printing paper, and outputs the printed image.

The control unit 16 is connected to the operation unit 11, the document-reading unit 12, the storage unit 13, the image-processing unit 14 and the printing unit 15, respectively. The control unit 16 is an information-processing unit such as a microcomputer or the like that includes ROM, RAM and the like. The ROM stores a control program for performing operation control of the image forming apparatus 1. The control unit 16 reads the control program that is stored in the ROM and by expanding the control program in the RAM, performs overall control of the image forming apparatus. Moreover, the control unit 16 causes the touch panel 111 to display a password-entry screen G80 as illustrated in FIG. 2, functions as a character-input unit 161, comparison-processing unit 162, a touch-mistake-detection unit 163, and an authentication-processing unit 165, and has a function for performing user authentication.

A password-entry area 82 in which the entered password 81 is entered, a software keyboard 84 that is used for entering the entered password 81, and an OK button B86 for authenticating that the entered password 81 is correct are provided on the password-entry screen G80.

The software keyboard 84 has plural input keys 83 that indicate characters, number or symbols (hereafter, referred to as “characters and the like”), and the plural input keys 83 are arranged in plural rows. The input keys 83 are touch operated, and are operation keys for entering pre-assigned characters and the like into the password-entry area 82.

The character-input unit 161 has a function of, each time the touch panel 111 detects that an input key 83 has been touch operated, entering the character or the like that is indicated by the touch operated input key 83 in order into the password-entry area 82 as the nth character (n is a natural number) of the entered password 81. In order to maintain security, the entered password 81 that is entered into the password-entry area 82 is displayed as a turned character such as an asterisk “*” or the like.

The comparison-processing unit 162 has a function of, each time an nth character of the entered password 81 is entered into the password-entry area 82 by the character-input unit 161, comparing that nth character with a corresponding nth character of a set password 131.

The touch-mistake-detection unit 163 has a function of, when the comparison result by the comparison-processing unit 162 indicates there is no match, detecting a touch mistake by the user for the nth character of the entered password 81 based on the arrangement position of the input key 83 that is touch operated on the software keyboard 84.

The correction-processing unit 164 has a function of, when a touch mistake is detected by the touch-mistake-detection unit 163, correcting the nth character of the entered password 81 to the nth character of the set password 131. When the comparison result by the comparison-processing unit 162 indicates that there is a match, or when no touch mistake is detected by the touch-mistake-detection unit 163, does not correct the nth character of the entered password 81.

The authentication-processing unit 165, by the OK button B86 being pressed, has a function of comparing an entered password 81 that is entered in the password-entry area 82 with the set password 131, determining that authentication is successful when there is a match, and determining that authentication failed when there is no match. When it is determined that authentication is successful, for example, login corresponding to the authenticated user, use of the image forming functions, and the like become possible, and when it is determined that authentication failed, re-entry of the entered password 81 is requested.

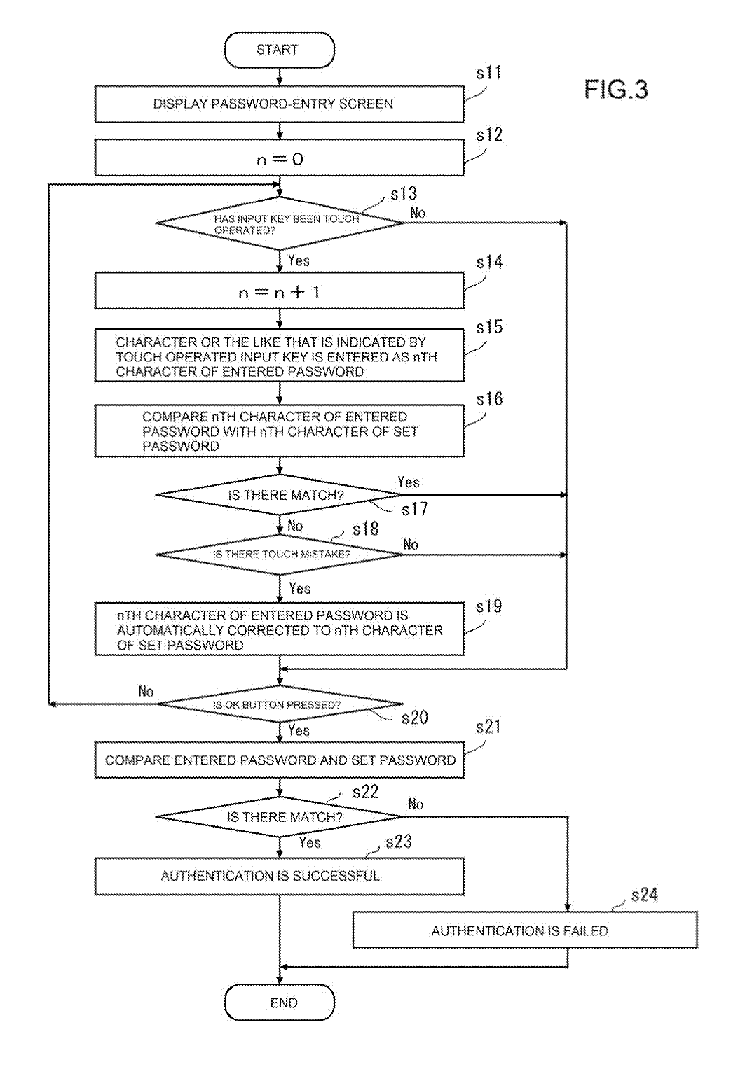

Next, the flow of the password-authentication process of the image forming apparatus 1 is explained with reference to FIG. 3.

The control unit 16 causes the operation unit 11 to display the password-entry screen G80 (step S11), and functions as the character-input unit 161. The character-input unit 161 initializes the value of n that is a variable for counting the number of characters that have been entered as the entered password 81 to n=0 (step S12). Continuing, the character-input unit 161 determines whether or not a touch operation of an input key 83 is detected by the touch panel 111 (step S13). When an input key 83 has not been touch operated (step S13: NO), it is determined whether the OK button 86 has been pressed (Step S20), and when the OK button 86 has not been pressed (step S20: NO), processing returns to step S13.

When a touch operation of an input key 83 is detected by the touch panel 111 (step S13: YES), the character-input unit 161 increments the value n (step S14), and enters the character or the like that is indicated by the touch operated input key 83 into the password-entry area 82 as the nth character of the entered password 81 (step S15).

When the nth character of the entered password 81 is entered by the character-input unit 161, the comparison-processing unit 162 compares the nth character of the entered password 81 with the nth character of the set password 131 that is stored in the storage unit 13 (step S16).

When the comparison result indicates that there is no match (step S17: NO), the touch-mistake-detection unit 163 detects a touch mistake of the nth character of the entered password 81 (step S18).

For example, when the comparison results show that the non-matching input key 83 (touch operated input key 83) that indicates the nth character of the entered password 81 is adjacent on the software keyboard 84 to the input key 83 that indicates the nth character of the corresponding set password 131, the touch-mistake-detection unit 163 detects as a touch mistake.

More specifically, when the first character of the entered password 81 is taken to be “a” and the first character of the set password 131 is taken to be “s”, and when both are compared by the comparison-processing unit 162, it is determined that there is no match. The comparison result indicates that there is no match, so the touch-mistake-detection unit 163 identifies the arrangement position of the input key 83 that indicates “a” on the software keyboard 84 in FIG. 2, and identifies the arrangement position of the input character that indicates “s” on the software keyboard 84 in FIG. 2, and determines whether or not the input key 83 that indicates “a” is adjacent to the input key 83 that indicates “s”. In this case, the input key 83 that indicates “a” and the input key 83 that indicates “s” are adjacent, so the touch-mistake-detection unit 163 detects this as a touch mistake. When the keys are not adjacent, the touch-mistake-detection unit 163 does not detect a touch mistake.

Moreover, the touch-mistake-detection unit 163 sets a touch-mistake range 85 on the software keyboard 84 in which touch mistakes are allowed, with the input key 83 that indicates the nth character of the set password 131 that corresponds to the input key 83 that indicates the nth character of the entered password 81 for which the comparison result indicated that there is no match as the center. Then, when the touch position of the input key 83 that indicates the non-matching nth character of the entered password 81 is included in the set touch-mistake range 85, this may be detected as a touch mistake.

In this case, the touch-mistake-detection unit 163 sets a touch-mistake range 85 on the software keyboard 84 that allows a touch mistake, with the input key 83 that indicates the nth character of the set password 131 (for example, “s”) as the center. The touch-mistake range 85 illustrated in FIG. 2 is set as a rectangular shape having a size that includes parts of each of the key areas (display areas for keys 83) for the input keys 83 (“a”, “w”, “e”, “d”, “x”, “z”) that are adjacent to the input key 83 that indicates the nth character (“s”) of the set password 131. Moreover, the touch-mistake area 85 is set so as to diagonally cover the input key 83 that indicates the nth character (“s”) of the set password 131.

Continuing, the touch-mistake-detection unit 163 obtains from the touch panel 111 the touch position for which touching was performed of an input key 83 that indicates the nth character (for example, “a”) of the entered password 81, and determines whether or not the touch position is included in the touch-mistake range 85. When the touch position is included in the range, the touch-mistake-detection unit 163 detects the touch position as a touch mistake, and when the touch position is not included in the range, does not detect the touch position as a touch mistake. In other words, this is a case in which the input key 83 that indicates the nth character of the entered password 81 is adjacent to the input key 83 that indicates the nth character of the set password 131. In addition, this is a case in which the touch position of the input key 83 that indicates the nth character of the entered password 81 is near the input key 83 that indicates the nth character of the set password 131. That is, this is a case in which the touch position is included in the touch-mistake range 85. In these cases, the touch operation is detected as a touch mistake.

As a result, the touch-mistake-detection unit 163 is able to detect a case in which an input key 83 that is near the input key 83 that indicates the nth character of the set password 131 is touch operated as a touch mistake.

When a touch mistake is detected (step S18: YES), the correction-processing unit 164 automatically corrects the nth character of the entered password 81 to the nth character of the set password 131 (step S19). As a result, the entered password 81 that was mistakenly entered by the user with a touch mistake is automatically corrected as if the correct entered password 81 had been entered.

However, when a touch mistake is not detected by the touch-mistake-detection unit 163 (step S18: NO), or when the comparison result indicates that there is a match (step S17: YES), the correction-processing unit 164 does not perform correction of the nth character of the entered password 81, and processing advances to step S20.

Continuing, the authentication-processing unit 165 determines whether or not a touch operation of the OK button B86 is detected by the touch panel 111 (whether or not the OK button B86 has been pressed) (step S20). When the OK button B86 has not been pressed (step S20: NO), processing returns to step S13. Therefore, every time a user enters character or the like of the entered password 81 using the software keyboard 84, whether or not there is touch mistake is detected, and when a touch mistake is detected, the entered character or the like is automatically corrected to the correct character and the like.

The user finishes entering the entered password 81 and then presses the OK button B86. When the OK button B86 is pressed (step S20: YES), the authentication-processing unit 165 compares the entered password 81 that is entered in the password-entry area 82 with the set password 131 (step S21).

When a touch mistake is detected in the entered password 81 by the touch-mistake-detection unit 163, and the entered password 81 is corrected by the correction-processing unit 164, the authentication-processing unit 165 performs authentication by comparing the corrected entered password 81 and the set password 131. In other words, when a touch mistake in the entered password 81 is detected by the touch-mistake-detection unit 163, the authentication-processing unit 165 authenticates the entered password 81 as the set password 131 being entered.

When the comparison result indicates there is a match (step S22: YES), the authentication-processing unit 165 determines that authentication is successful (step S23), and when the comparison result indicates there is no match (step S22: NO), the authentication-processing unit 165 determines that authentication failed (step S24), and ends this process.

In this way, the image forming apparatus 1 that functions as the authenticating device includes a touch panel 111, an authentication-processing unit 165 and a touch-mistake-detection unit 163. The touch panel 111 displays a software keyboard 84 on which plural input keys 83 that indicate characters, numbers or symbols are arranged, and receives touch operations of input keys 83 that correspond to touch positions on the display screen that displays the software keyboard 84. The authentication-processing unit 165 executes user authentication by comparing an entered password 81 that is entered via the touch panel 111 and a set password 131. When the comparison results indicate that there is no match, the touch-mistake-detection unit 163 detects a touch mistake in the entered password 81. When a touch mistake is detected, the authentication-processing unit 165 authenticates the entered password 81 as the set password 131 being entered. In this way, when a touch mistake is detected in an entered password 81, the entered password 81 is authenticated as the set password 131 being entered, so an entry error of the entered password 81 due to a touch mistake is deleted, and it is possible to reduce re-entry of the entered password 81.

The touch-mistake-detection unit 163 may obtain the tendency of touch mistakes by a user based on the touch position of an nth character of an entered password 81 in which a touch mistake is detected and the arrangement position on the software keyboard 84 of an input key 83 that indicates the nth character of a set password 131, and may store that tendency in RAM, the storage unit 13 or the like. For example, the direction or distance of the touch position from the input key 83 that indicates the nth character of the set password 131 may be taken to be the touch-mistake tendency of the user. When a touch mistake is detected, the correction-processing unit 164 determines whether or not the current touch-mistake tendency is the same as the previous touch-mistake tendency. Then, when the touch-mistake tendency is the same, the nth character of the entered password 81 may be automatically corrected to the nth character of the set password 131. In this way, when the user makes the same touch mistake as in the previous time, the authentication-processing unit 165 authenticates the entered password 81 as the set password 131 being entered, so it is possible to increase security. When a current touch-mistake tendency is within a range of plural previous touch-mistake tendencies that are stored in RAM or the storage unit 13, the touch-mistake-detection unit 163 may determine that the touch-mistake tendency is the same.

In the embodiment described above, every time a nth character of an entered password 81 is entered, the nth character of the entered password 81 is compared with the nth character of the set password 131, and when the comparison result indicates that there is no match, whether or not there is a touch mistake is detected, however, this may be executed at the timing when the OK button B86 is pressed. In other words, in the process by the authentication-processing unit 165 for comparing the entered password 81 with the set password 131, when there is a non-matching character between the entered password 81 and the set password 131, the touch-mistake-detection unit 163 may detect whether or not there is a touch mistake for that character. When a touch mistake is detected, the authentication-processing unit 165 may authenticate the entered password 81 as the set password 131 being entered in a state in which the correction-processing unit 164 has properly corrected the entered password 81. Moreover, when a touch mistake is detected, the authentication-processing unit 165 may also authenticate the entered password 81 as the set password 131 being entered even when the correction-processing unit 164 does not correct the entered password 81.

In one of the typical technologies described above, there is a problem with security in that characters that are entered as a password are noticeably displayed. Moreover, in another of the typical technologies described above, there is a problem in that by displaying only the characters that are correctly entered so as to be unrecognizable, it is known which number position of the characters of the mistakenly entered password are correct, and a third party that does not know the password may arrive at the correct password by repeatedly entering the password many times.

According to the present disclosure, in a state of maintaining security, it is possible to reduce errors in entering a password due to touch mistakes.

The present disclosure is not limited to the embodiments described above, and needless to say various modifications are possible without departing from the scope of the present disclosure.

What is claimed is:

1. An authenticating device, comprising:
a touch panel that displays a software keyboard on which plural input keys are arranged that indicate characters, numbers and symbols, and receives touch operations of input keys that correspond to touch positions on a display screen on which the software keyboard is displayed;
an authentication-processing unit that executes user authentication by comparing an entered password that is entered via the touch panel and a set password; and
a touch-mistake-detection unit that detects a touch mistake in an entered password when the comparison result indicates there is no match; wherein
the authentication-processing unit authenticates the entered password as the set password being entered when a touch mistake is detected.

2. The authenticating device according to claim 1, wherein
the touch-mistake-detection unit
detects the case in which the input key that indicates a character, number or symbol of the entered password for which the comparison results indicates no match is adjacent on the software keyboard to the input key that indicates the corresponding character, number or symbol of the set password as a touch mistake.

3. The authenticating device according to claim 1, wherein
the touch-mistake-detection unit
detects the case in which a touch-mistake range that allows a touch mistake is set on the software keyboard with the input key that indicates a character, number or symbol of the set password that corresponds to a character, number or symbol of the entered password for which the comparison result indicates there is no match as the center, and the touch position of the input key that indicates the non-matching character, number or symbol of the entered password is included in the touch-mistake range as the touch mistake.

4. The authenticating device according to claim 1, wherein
the touch-mistake-detection unit,
when a touch mistake is detected, obtains the tendency for the touch mistake based on the arrangement position on the software keyboard of the touch position of the input key that indicates a character, number or symbol of the entered password for which the touch mistake is detected, and the input key that indicates the corresponding character, number or symbol of the set password; and
the authentication-processing device authenticates the entered password as the set password being entered when the tendency of the current touch mistake is the same as the tendency of the previous touch mistake.

5. An image forming apparatus comprising the authenticating device according claim 1.
